(19) United States
(12) Patent Application Publication
(10) Pub. No.: US 2015/0014240 A1
(43) Pub. Date: Jan. 15, 2015

(54) FILTER MEDIA FOR GRAVITY FILTRATION APPLICATIONS

(71) Applicant: KX Technologies LLC, West Haven, CT (US)

(72) Inventors: Stephen P. Huda, Shelton, CT (US); Andrew Lombardo, West Haven, CT (US); Bruce Taylor, Cheshire, CT (US); Frank A. Brigano, Northford, CT (US)

(21) Appl. No.: 14/328,067

(22) Filed: Jul. 10, 2014

Related U.S. Application Data
(60) Provisional application No. 61/845,595, filed on Jul. 12, 2013.

(51) Int. Cl. B01D 29/00

(52) U.S. Cl. CPC B01D 29/00; B01D 29/0093
USPC 210/491; 29/428

(57) ABSTRACT

A gravity filter media fabricated from multiple spiral wound or pleated layers, where different layers are designed for specific contaminant removal process and the layers are combined into a single pack for ease of use. The layers or fiber sheets are chemically treated for contaminant removal, with different layers having different chemical treatments, or the layers are immobilized with particles of various sizes for use as low contact-time adsorbents, with different layers having different immobilized particles, or the pore structure is varied from one fiber sheet to another—one being a tight pore structure, and the other being a more open pore structure, or any combination thereof. When using immobilized particles, the immobilized particles can be chemically treated for the specific removal of targeted contaminants, and multi-layered for custom designed removal of specific contaminants.

### BACKGROUND OF THE INVENTION

1. Field of the Invention

The present invention relates to a filter, preferably a gravity filter, comprising multiple spiral wound or pleated layers, where each layer is designed for a specific contaminant removal process, and the layers are pleated into a single pack for ease of use. The present invention further relates to the immobilization of particles of various sizes within the fibers of a filter sheet for use as low contact-time adsorbents. The particles can be chemically treated for the specific removal of targeted contaminants, and multi-layered for designed, targeted removal of a plurality of specific contaminants.

2. Description of Related Art

Gravity filtration is one of the oldest ways of filtering water. Starting from a simple filter cloth to remove suspended impurities to carbon granules along with certain ion exchange media to remove chlorine and certain heavy metals, gravity filtration systems generally include upper and lower chambers separated by a filter cartridge. The system relies on gravity force of the untreated water in the upper chamber to force the water through the cartridge and into the lower chamber thereby producing filtered water. One such gravity filtration system commonly used in homes is the carafe type of filter housing with the top container having a capacity on the order of one-half gallon. The gravity pressure of the untreated water is sufficient to force the water through a limited amount of activated carbon granules and ion exchange resins to the reservoir holding the filtered water.

Activated carbon granules used in home purification devices are used to remove bad taste and odor. They remove chlorine and other reactive chemicals dissolved in the water. Carbon blocks made of activated carbon powder have enormous surface area to remove volatile organic chemicals (VOCs) besides bad taste and odor. Depending on particle size and particle size distribution of carbon particles, carbon blocks filters can be of varied nominal porosity.

Filter media may also be formed of a web or sheet of fibers. The fiber sheet provides a porous structure that permits fluid to flow through the filter media. Contaminant particles contained within the fluid may be trapped on the fibrous sheet. Filter media characteristics, such as fiber diameter and level of fibrillation affect filter performance including filter efficiency, contaminant holding capacity, and resistance to fluid flow through the filter.

The filter media described herein includes fibrillated fibers, such as lyocell fibers, and the like. As known to those of ordinary skill in the art, a fibrillated fiber includes a parent fiber that branches into smaller diameter fibrils which can, in some instances, branch further out into even smaller diameter fibrils with further branching also being possible. The branched nature of the fibrils leads to a high fiber surface area and can increase the number of contact points between the fibrillated fibers and the fibers in the sheet. The level of fibrillation relates to the extent of branching in the fiber.

Standards have been developed and promulgated to regulate the amount of contaminants allowed in drinking water. For example, one such standard is NSF/ANSI 53, entitled “DRINKING WATER TREATMENT UNITS—HEALTH EFFECT.” This is an NSF International Standard and an American National Standard for establishing minimum requirements for materials, design, construction, and performance of point-of-use and point-of-entry drinking water treatment systems that are designed to reduce specific health-related contaminants in public or private water supplies. This standard, as well as other related standards and protocols, governs the amount of contaminants in drinking water, such as lead, governs testing protocols for removal of those contaminants which provides a benchmark for the efficacy of water filters designed to remove or reduce such contaminants. For example, pursuant to the NSF requirement, the influent challenge for total lead is 0.15 mg/L (150 ppb) of which 30% (50 ppb) is total particulate lead, and 20% of the total particulate lead (20 ppb) is fine lead between 0.1 and 1.2 microns in size. The maximum effluent lead concentration is 0.010 mg/L. The total lead requirement is applicable for lead pH 6.5 and lead pH 8.5 reduction testing. The lead particulate and fine lead values are of the greatest concern for lead pH 8.5 testing. A filter designed to specifications of the present invention is capable of meeting the NSF or other similar standard challenge requirements for the reduction of lead in drinking water.

A more recent patent on filter media, U.S. Pat. No. 6,872,311 issued on Mar. 29, 2005, entitled “NANOFIBER FILTER MEDIA,” describes the use of nanofibers as an enhanced filtration medium. The patent teaches that the physical process of fibrillation enhances the performance of standard filter media such as cellulose fiber. Moreover, this patent also teaches a process for making an improved filter medium with the incorporation of nanofibers. This process has also been commercialized for filtration purposes in combination with activated carbon.

Although contaminants may be targeted by the application of a fluid filtration system, it is known that granulated activated carbon (GAC) filters and ion exchange loose filter media configurations do not remove particulate materials well; nor can they successfully remove complex forms of heavy metals. There remains a need in the art to remove more efficiently, and more completely, particulate materials and complex forms of heavy metals. Consequently, there is a need in the art to develop filter media that overcomes the deficiencies of the GAC and ion exchange loose filter media.

The concept of targeting specific contaminants while maintaining a robust flow rate, which is the premise of the present invention, is novel to the art.

### SUMMARY OF THE INVENTION

Bearing in mind the problems and deficiencies of the prior art, it is therefore an object of the present invention to merge the capability of multiple, specifically treated fiber sheets into a single pleated filter media for the purpose of targeting simultaneously uniquely different contaminants, and therefore, custom designing a filter media for a specific purpose.

It is another object of the present invention to provide multiple layers of fiber sheets into a pleated filter media, or spiral wound media where separate layers are each capable of removing at least one specific targeted contaminant, respectively, in the fluid filtering through the filter media by immobilizing adsorbing particles within the fiber sheets of the filter media.

It is a further object of the present invention to provide a filter media custom designed for certain contaminants while improving flow rate during gravity-fed applications.

The above and other objects, which will be apparent to those skilled in the art, are achieved in the present invention which is directed to a filter media comprising at least two separately treated fiber sheets including: a first type of fiber sheet treated for targeting a first contaminant in a fluid; and a second type of fiber sheet treated for targeting a second contaminant in the fluid, the second contaminant being different from the first contaminant; wherein, the two types of fiber sheets are then combined into a single filter media.

The filter media may be a combination of at least two types of fiber sheets into a pleated filter media or into a spiral wound filter media.

The at least two types of fiber sheets may be open pore structure and dense pore structure sheets respectively. They may also be chemically treated, the first type of fiber sheet having a first chemical treatment to reduce a first contaminant in the fluid, and the second type of fiber sheet having a second chemical treatment to reduce a second contaminant in the fluid, the first chemical treatment being different from the second chemical treatment.

The at least two types of fiber sheets may be immobilized with adsorbent particles, the first type of fiber sheet immobilized with a first adsorbent particle type to adsorb the first contaminant in the fluid, and the second type of fiber sheet immobilized with a second adsorbent particle type to adsorb the second contaminant in the fluid, the first adsorbent particle type being different from the second adsorbent particle type.

Alternatively, the at least two types of fiber sheets may be treated to reduce contaminants in a fluid, with the first type of fiber sheet having a chemical treatment to reduce a first contaminant in the fluid, and the second type of fiber sheet immobilized with adsorbent particles to reduce a second contaminant in the fluid.

At least one type of fiber sheets may immobilized with adsorbent particles that are chemically treated for adsorbing or reducing a contaminant in the fluid.

The filter media may include chemically treated carbons particles immobilized in sheets of fibrillated nanofibers to target the removal of mono-chloramine.

The filter media may include urea treating or ammonia treating immobilized particles in sheets of fibrillated nanofibers, or immobilizing carbon fibers or carbon nanotubes in the fiber sheets for the removal of mono-chloramine.

The filter media may target volatile organic compounds (VOCs) through the immobilization in fiber sheets of particles of activated carbon, coconut carbon, high activity carbon, chemically treated carbon, carbon fibers, or carbon nanotubes.

The filter media may target heavy metals through the immobilization in fiber sheets of particles of titanium dioxide, titanium alumina silicate, molecular sieves, zeolites, bone char carbon, oxidized carbon, or chemically treated carbon.

The filter media may target viruses through the immobilization in fiber sheets of particles of activated alumina, high zeta potential materials, metal oxides, or cationic polymers.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts an apparatus for pleating fibers sheets capable of combining multiple fiber sheets having different filtering characteristics into a single pleated filter media;

FIG. 2 depicts an SEM photograph of a fiber sheet immobilized with particles for the targeting of a predetermined, targeted contaminant;

FIG. 3 depicts the fiber sheet of FIG. 2 after filtration and the capture of the predetermined, targeted contaminant; and

FIG. 4 depicts a graph of the results of the two filters under test for targeting high pH lead.

### DESCRIPTION OF THE PREFERRED EMBODIMENT(S)

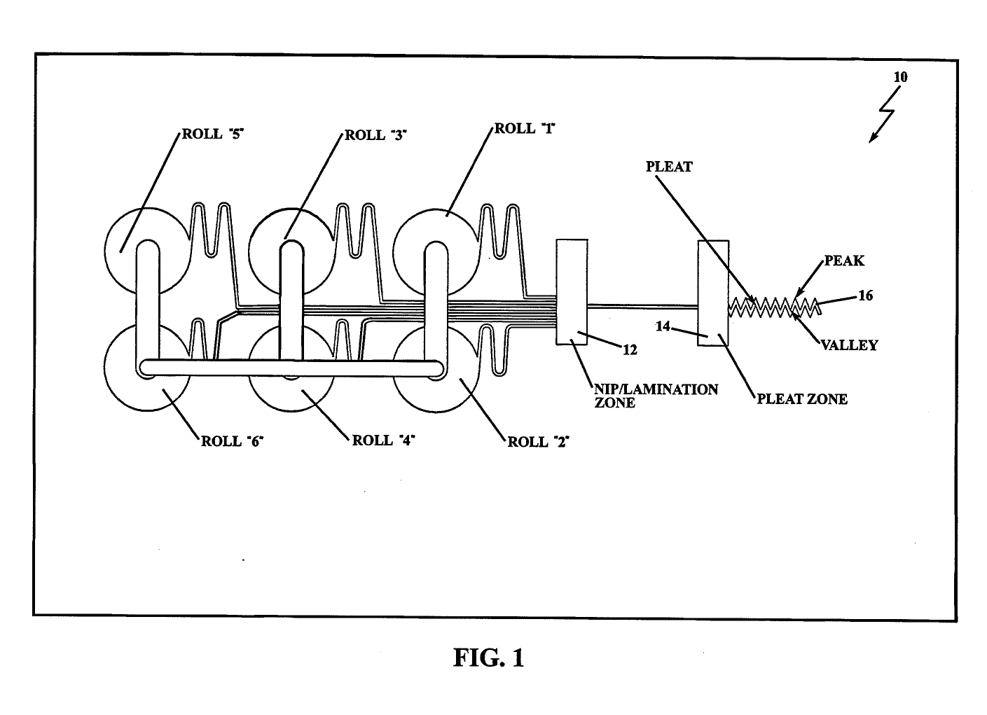

In describing the preferred embodiment of the present invention, reference will be made herein to FIGS. 1-4 of the drawings in which like numerals refer to like features of the invention.

In a first embodiment, the present invention is directed to a filter media composed of at least two types of treated fiber sheets. At least one of the fiber sheets is characteristically designed to target a first contaminant contained in the fluid to be filtered, another fiber sheet being characteristically designed to target a second contaminant contained in the fluid, the second contaminant being different from the first contaminant.

The fiber sheets are then combined via a pleating process to form a pleated filter media having the filtering attributes of each different fiber sheet. The placement order of the treated fibers sheets may be subject to the particular treatment and contamination reduction results desired. The placement may affect filtration flow and performance. Care needs to be taken to assess the particular contaminants selected for filtration, insomuch as competing adsorbents could incur detrimental filtration effects if not accounted for. Thus, the combination of independent treatments must be fully considered for any adverse effects subject to the combination.

FIG. 1 depicts a pleating apparatus 10 capable of combining multiple fiber sheets having different filtering characteristics into a single pleated filter media. In this exemplary assembly, six rolls of fiber sheets are depicted (Roll 1-Roll 6), each capable of delivering a different fiber sheet for filtering, although the present invention may include just two different fiber sheets targeting different contaminants. In this exemplary example, each fiber sheet is designed to target a specific contaminant. The sheets are combined in a lamination step 12, and then pleated 14 as a single filter media 16. The sheets could also be combined in a spiral wound configuration.

A layer of the combined pleated fiber sheets could, for example, be fabricated and/or treated to remove lead. Another layer may be fabricated and/or treated to remove volatile organics, and a third layer fabricated and/or treated to remove sediment, and so on for each additional layer. Again, adverse effects must be considered when combining different treated fiber sheets; however, numerous combinations are possible when treating a plurality of contaminants with multiple treated fiber sheets.

For example, when making a filter for removing bacteria and virus, there can be organic chemicals in the water that interfere with electrostatic adsorption of the bacteria and virus. Adding multiple chemistries to a single layer can add complications; thus, it is preferable to use a first layer to remove the organic chemicals from the water so the water is free from these chemicals and allow the second layer to remove the bacteria/virus without competing chemicals.

In the apparatus of FIG. 1, it is possible to merge six distinct fiber sheets into a pleated filtering media. Essentially, each layer or fiber sheet giving the advantage of providing a unique characteristic filter media custom designed to target user specific contaminants.

Chemically treating fiber sheets for use as filter media has been shown to achieve desirable results in the degradation and removal of certain unwanted contaminants in a fluid. The present invention introduces a combination of different treated fiber sheets in one single filter media, which may be pleated or spiral wound, as a means for custom designing the filter's filtration spectrum while maintaining sufficient fluid flow during gravity-fed applications. If, instead of combining fiber sheets of different treatments into a single filter media as suggested by the present invention, separate, chemically treated filter media were combined, the effective flow rate would be significantly reduced, and the application of the multiple filter media would not lend itself for gravity filtration. The present invention overcomes this unwanted reduction in fluid flow, while achieving targeted contaminant removal.

Aside from chemically treating fiber sheets, another form of treatment of the fiber sheets is to immobilize particles of various sizes with the fiber. Small sized particles, including nanoparticles, are of great technological importance for water purification. Due to their small size and high surface area, they own distinguished properties and high efficiency. However, also because of their small size, they are difficult to be handled and recovered in practice. Thus, it remains a technical challenge to immobilize these small particles on substrates or fiber sheets.

This combination of multiple fiber sheets each immobilized with different predetermined particles for targeting specific contaminants has been shown to be advantageous in gravity-fed filtering applications. For example, the use of particles on the order of, or less than, 150 microns in diameter for adsorbents, immobilized into a sheet that can be pleated or spiral wound into a single filter media for gravity-fed filtering applications has been shown to provide enhanced filtration performance while exhibiting low contact time and providing sufficient flow rate. Preferably, the ideal particle size for immobilizing fiber sheets is between 10 microns and 50 microns, although the present invention is not limited to any particular particle size provided the particles are capable of being immobilized in fiber sheets and responsive to the fiber sheet manipulation during a pleating or spiral wound process. The use of particles of less than 150 microns in diameter immobilized in fiber sheets allows for a thin sheet with high kinetic capacity for reduction of chemicals at a vastly faster filtering rate than a GAC filter media, which is the common filter media for gravity filtration applications in the prior art.

These particle adsorbents may also be chemically treated and custom designed or specifically targeted to remove predetermined contaminants. For example, chemically treated carbons may be immobilized in sheets of fibrillated nanofibers to target the removal of mono-chloramine. The carbon may also be urea treated or ammonia treated for this purpose as well. Mono-chloramine may also be targeted through the introduction and immobilization of carbon fibers or carbon nanotubes in the fiber sheets.

Volatile organic compounds (VOCs) may be targeted through the introduction and immobilization in fiber sheets of particles of activated carbon, coconut carbon, high activity carbon, chemically treated carbon, carbon fibers, or carbon nanotubes.

Heavy metals may be targeted through the introduction and immobilization in fiber sheets of particles of titanium dioxide, titanium alumina silicate, molecular sieves, zeolites, bone char carbon, oxidized carbon, or chemically treated carbon.

Viruses may be targeted through the introduction and immobilization in fiber sheets of particles of activated alumina, high zeta potential materials, metal oxides, or cationic polymers.

Particulates may be targeted through the introduction and immobilization in fiber sheets of particles of additional nanofibers, microfibers, cellulose, polyethylene, or polyacrylonitrile (PAN).

Bacteria may be targeted through the introduction and immobilization in fiber sheets of particles of additional nanofibers, microfibers, or carbon nanotubes.

The aforementioned list of elements for immobilization is a representative sample for targeting predetermined contaminants. This listing is not intended to be an exhaustive list of the various particles that can be introduced (immobilized) into different fiber sheets for specific targeting; however, as a representative sample, it provides for the implementation of a single filter media of the present invention, specifically the combination of differently treated fiber sheets, each separately immobilized with particles for targeting uniquely different contaminants.

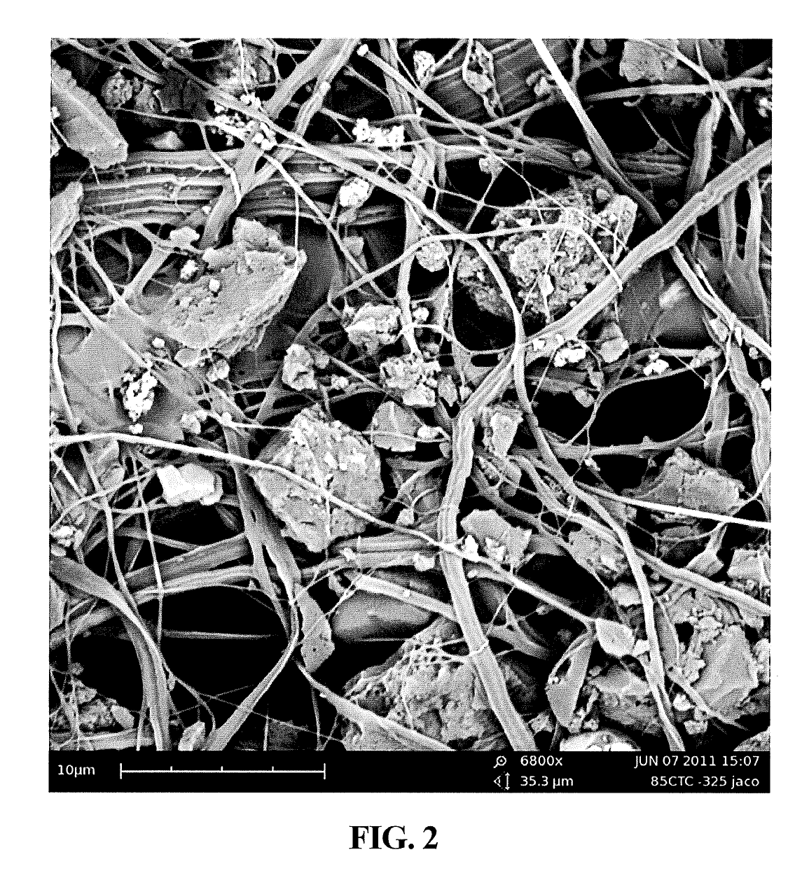

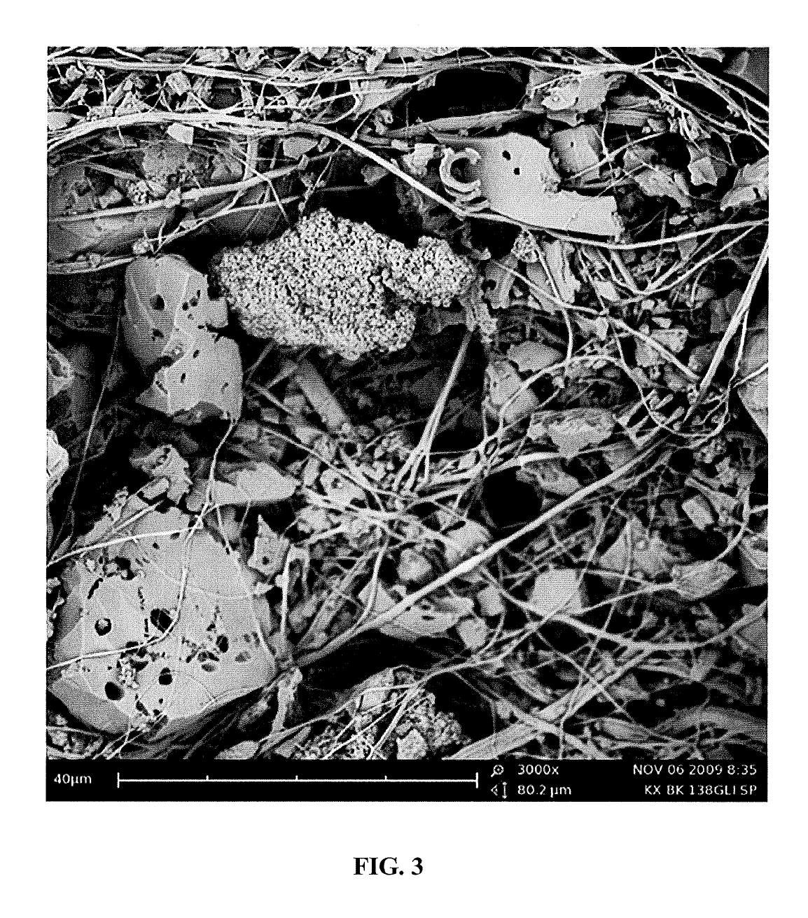

FIG. 2 depicts an SEM photograph of a fiber sheet immobilized with carbon particles for the targeting of a predetermined contaminant. FIG. 3 depicts an SEM photograph of a fiber sheet immobilized with titanium and carbon particles for the targeting of a predetermined contaminant.

### Test Results

Testing of a filter media of the present invention was performed in a gravity-flow application specifically targeting high pH lead. The first sheet had an open pore structure of carbon and lead adsorbent, and the second sheet had a much tighter pore structure with more nanofibers along with carbon and lead adsorbent. In this example, the lead contaminant is actually two different contaminants: soluble lead, and particulate lead, which are being removed as two different contaminants, even though they are chemically similar.

Each filter media under test was hot glued into a filter housing to ensure that no bypass of contaminated influent could occur at the seal edges. The filters were formed of multiple fiber sheets and pleated. Each filter was tested for a first pass efficiency and then dried overnight at 60° C. The filters were soaked for 15 minutes then exposed to two liters of water. The filters were then tested according to the NSF standard 53 (7.4.3 Lead Reduction Testing). Each filter was exercised at a rate of 5 gallons per day. Flow rate was monitored by measuring the amount of time to collect the first 500 ml of water, and for the entire liter.

Table 1 depicts the numerical results of the aforementioned testing protocol.

TABLE 1
NSF Test Data

| Test Point | | Influent Data | | | | | Filter 1 | | | Filter 2 | | |
|---|---|---|---|---|---|---|---|---|---|---|---|---|
| | Gallons | Total | 0.1 | 1.2 | % | | Flow Rate | Effluent | % Reduction | Flow Rate | Effluent | % Reduction |
| # | Filtered | Lead | Filtered | Filtered | Particulate | % Fines | (ml/s) | 1 | 1 | (ml/s) | 2 | 2 |
| 1 | 0 | 145.0 | 100.6 | 122.5 | 30.6% | 49% | 6.5 | 0.9 | 99.4% | 6.5 | 1.1 | 99.1% |
| 5 | 20 | 153.4 | 91.3 | 143.6 | 40.5% | 84% | 5.1 | 3.8 | 97.5% | 5.5 | 3.7 | 97.4% |
| 9 | 40 | 154.3 | 103.6 | 139.0 | 32.8% | 70% | 4.2 | 2.0 | 98.7% | 4.2 | 1.6 | 98.8% |
| 13 | 60 | 148.6 | 91.6 | 146.9 | 38.4% | 97% | 4.3 | 4.8 | 96.8% | 4.3 | 5.0 | 96.6% |
| 15 | 72 | 163.4 | 102.8 | 154.5 | 37.1% | 85% | 4.5 | 0.5 | 99.7% | 4.3 | 0.2 | 99.9% |
| 17 | 80 | 141.0 | 95.8 | 112.0 | 32.1% | 36% | 4.3 | 0.8 | 99.4% | 4.2 | 0.4 | 99.7% |

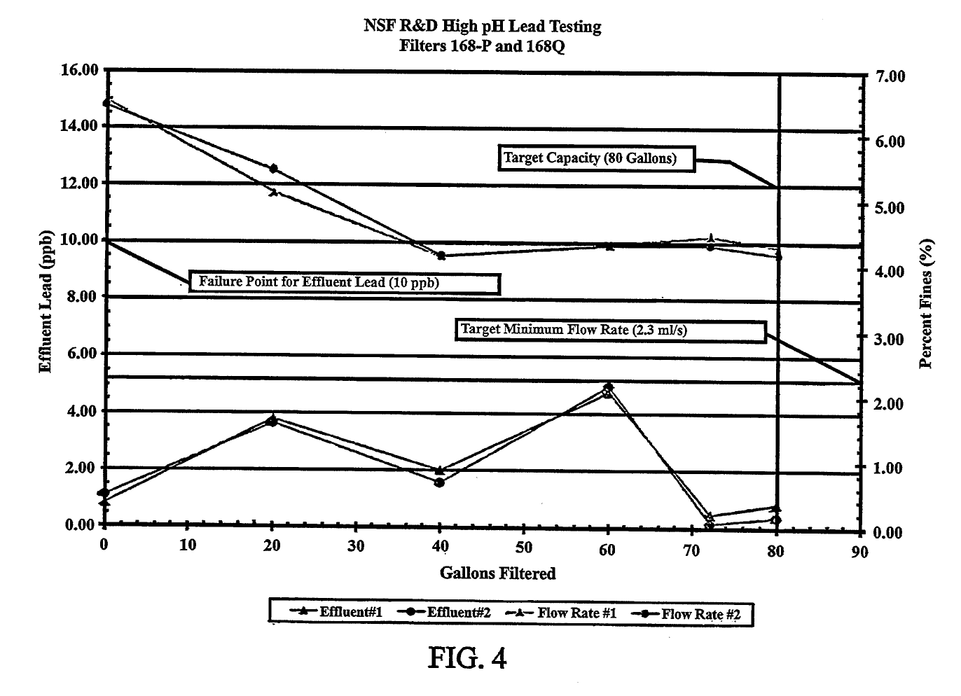

FIG. 4 depicts a graph of the results of the two filters under test for targeting high pH lead. As noted by the graph of FIG. 4, both filters under test exhibited exemplary results for the high pH lead testing, showing no greater than 5 ppb in the effluent over the life of the test. When the present fines in the influent stream decreased, the total lead in the effluent decreased. The filters were designed for the NSF high pH lead protocol to pass with greater than 75% fines throughout the life of the test. In this manner, any time the influent level drops below this mark, the effluent is expected to drop considerably.

Additionally, the target flow of the filters under test remained above 4 ml/s throughout the life of the test. The target minimum for the filter product was 2.3 ml/s for a total filtration time of 7 minutes per liter.

The average percent reduction was calculated in the following manner:

% Reduction={[influent average−effluent average]/influent average}*100

where,

influent average includes all influents up to and including a current sample point; and

effluent average includes all effluents up to and including a current sample point.

The percent total particulate was calculated from the following:

% Total Particulate={[Total lead−0.1 micron filtered lead]/Total lead}*100

where,

total lead is the total soluble and particulate lead in the sample; and

0.1 micron filtered lead is the total soluble lead.

And the percent fine particulate was calculated from the following:

$$\% Fine Particulate = \frac{\{ [ 1.2 micron filtered lead - 0.1 micron filtered lead ] \}}{Total lead - 0.1 micron filtered lead}$$

where,

0.1 micron filtered lead is the total soluble lead; and

1.2 micron filtered lead is the total soluble and particulate lead that is less than 1.2 microns in size.

The present invention demonstrates filter media embodiments capable of targeting multiple predetermined contaminants, which allows a user to customize a filter media for precise applications. For example, one filter media embodiment may represent the combination of different chemically treated fiber sheets into a pleated or spiral wound configuration. Each fiber sheet designed to filter a predetermined contaminant that is different than another fiber sheet in the media.

A second filter media embodiment may represent the introduction and immobilization of particles onto or within fiber sheets for the purpose of adsorbing and/or attracting contaminants.

A third filter media embodiment may represent the combination of chemically treated fiber sheets with fibers sheets immobilized with small adsorbent particles, again for the purpose of custom designing a single filter media for the precise targeting of predetermined contaminants.

Other filter media configurations are possible for specifically targeting a plurality of contaminants in a single design.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A filter media comprising at least two types of fiber sheets including:
a first type of fiber sheet treated for targeting a first contaminant in a fluid; and
a second type of fiber sheet treated for targeting a second contaminant in said fluid, said second contaminant being different from said first contaminant;
wherein, said at least two types of fiber sheets are combined into a single filter media.

2. The filter media of claim 1 including combining said at least two types of fiber sheets into a pleated filter media.

3. The filter media of claim 1 including combining said at least two types of fiber sheets into a spiral wound filter media.

4. The filter media of claim 1 wherein said at least one of said at least two types of fiber sheets is chemically treated to reduce said first contaminant.

5. The filter media of claim 4 wherein said at least two types of fiber sheets are chemically treated, said first type of fiber sheet having a first chemical treatment to reduce said first contaminant in said fluid, and said second type of fiber sheet having a second chemical treatment to reduce said second contaminant in said fluid, said first chemical treatment being different from said second chemical treatment.

6. The filter media of claim 1 wherein at least one of said at least two types of fiber sheets is immobilized with adsorbent particles.

7. The filter media of claim 6 wherein said at least two types of fiber sheets are immobilized with adsorbent particles, said first type of fiber sheet immobilized with a first adsorbent particle type to adsorb said first contaminant in said fluid, and said second type of fiber sheet immobilized with a second adsorbent particle type to adsorb said second contaminant in said fluid, said first adsorbent particle type being different from said second adsorbent particle type.

8. The filter media of claim 1 wherein said at least two types of fiber sheets are treated to reduce contaminants in a fluid, said first type of fiber sheet having a chemical treatment to reduce said first contaminant in said fluid, and said second type of fiber sheet immobilized with adsorbent particles to reduce said second contaminant in said fluid.

9. The filter media of claim 4 wherein at least one type of fiber sheets is immobilized with adsorbent particles that are chemically treated for adsorbing or reducing a contaminant in said fluid.

10. The filter media of claim 8 wherein said second type of fiber sheet immobilized with adsorbent particles includes having said adsorbent particles chemically treated.

11. The filter media of claim 1 wherein said at least two types of fiber sheets are distinguished by open and tight pore structure, respectively, to target first and second contaminants, respectively.

12. The filter media of claim 6 including having said at least one of said at least two types of fiber sheets chemically treated with carbons particles immobilized in a sheet of fibrillated nanofibers to target the removal of mono-chloramine.

13. The filter media of claim 6 including having said at least one of said at least two types of fiber sheets comprise urea treating or ammonia treating immobilized particles in a sheet of fibrillated nanofibers.

14. The filter media of claim 6 including immobilizing carbon fibers or carbon nanotubes in said at least one of said at least two types of fiber sheets for the removal of mono-chloramine.

15. The filter media of claim 6 including targeting volatile organic compounds (VOCs) through the immobilization of particles of activated carbon, coconut carbon, high activity carbon, chemically treated carbon, carbon fibers, or carbon nanotubes, in said at least one of said at least two types of fiber sheets.

16. The filter media of claim 6 including targeting heavy metals through the immobilization in fiber sheets of particles of titanium dioxide, titanium alumina silicate, molecular sieves, zeolites, bone char carbon, oxidized carbon, or chemically treated carbon, in said at least one of said at least two types of fiber sheets.

17. The filter media of claim 6 including targeting viruses through the immobilization in fiber sheets of particles of activated alumina, high zeta potential materials, metal oxides, or cationic polymers, in said at least one of said at least two types of fiber sheets.

18. The filter media of claim 6 wherein said immobilized particles include nanofibers, microfibers, cellulose, polyethylene, or PAN, or any combination thereof, in said at least one of said at least two types of fiber sheets.

19. A process for making a filter media, comprising:
providing a first fiber sheet treated for targeting a first contaminant in a fluid;
providing a second type of fiber sheet treated for targeting a second contaminant in said fluid; and
combining said first and second fiber sheets into a pleated or spiral wound filter media.

20. The process of claim 19 including combining additional fiber sheets, each of said additional fiber sheets treated to target different specific contaminants in said fluid, said different specific contaminants different from said first and second contaminants, and different from each other.
